(19) United States
(12) Patent Application Publication
(10) Pub. No.: US 2002/0105522 A1
(43) Pub. Date: Aug. 8, 2002

(54) Embedded memory architecture for video applications

(76) Inventors: Mahadev S. Kolluru, Sunnyvale, CA (US); Adrian E. Ong, Pleasanton, CA (US)

Correspondence Address: STUART T AUVINEN, 429 26TH AVENUE, SANTA CRUZ, CA, 95062-5319, US

(21) Appl. No.: 09/681,053

(22) Filed: Dec. 12, 2000

(51) Int. Cl. G06F 13/14

(52) U.S. Cl. 345/519

(57) ABSTRACT

A memory has a wide data bus to an associative array processor. An entire row of the memory is read to or written by the associative array processor in a single access cycle. A data I/O controller is also coupled to the wide data bus between the memory and associative array processor. The data I/O controller has multiplexers that select one word from the wide data bus for access by a word-width system bus. A block-access mode selects a multi-word block in a row for access. A register latches in a block or row from the wide data bus, and words from the register are then accessed by the data I/O controller. The wide data bus is at least 1024 bits wide, and can be 5760 bits wide, enough for the associative array processor to read an entire line of a graphics or video picture.

### BACKGROUND OF THE INVENTION

This invention relates to integrated circuits, and more particularly to embedded memory architectures suitable for video and other data-intensive applications.

Graphics and video processors typically operate on a large quantity of data that define one or more video pictures. Each picture is composed of a S×T array of picture elements (or “pixels”), where S is the number of lines in the picture and T is the number of pixels per line. S and T are typically defined by a particular video standard, if any, to which the picture conforms. Each pixel is represented by a particular number of bits, which again can be defined by the particular video standard. For example, a National-Television-Standards-Committee (NTSC) picture is typically digitized to 480×720 pixels, with each pixel having 8 bits of resolution.

To expedite graphics and video processing, the data is typically stored in a local memory that couples directly to a data processor. The memory can be implemented as a video random access memory (VRAM), a dynamic random access memory (DRAM), a static random access memory (SRAM), a FLASH memory, or a combination thereof.

In many conventional graphics/video processors, the bus between the memory and the data processor is 16, 32, or 64 bits wide. These relatively narrow bus widths create bottlenecks in the graphics/video processors and limit the throughput rate.

To alleviate the bottlenecks, some graphics/video processors utilize a wide data bus between the memory and the data processor. One such graphics/video processor is disclosed in U.S. Pat. No. 5,694,143, which describes a wide data bus between the memory and data processor. While the wide data bus greatly expedites the transfer of data between the memory and data processor, it introduces additional design challenges. For example, such a wide data bus tends to dissipate much greater power when all data lines are active. Moreover, a mechanism is required to efficiently interface the memory to a relatively narrow (e.g., 32-bit wide) system bus, which is often used by other units and devices to exchange data with the memory.

Thus, memory architectures that provide a high data transfer rate and efficient interface with system devices are highly desirable.

### Brief Description of Drawings

FIG. 1 shows a simplified block diagram of a specific embodiment of a graphics and video processing system.

FIG. 2 shows a graphical representation of a specific partition of memory.

FIG. 3 shows a block diagram of a portion of a graphics/video processor, which highlights the data bus interconnections between the elements in the processor.

FIG. 4 shows a diagram of a specific embodiment of a memory, which is a specific implementation of the memory.

FIG. 5A shows a diagram of a specific embodiment of a memory address representation for the word access mode.

FIG. 5B shows a diagram of a specific embodiment of a memory address representation 520 for the block access mode for the specific embodiment shown in FIG. 4.

FIG. 5C shows a diagram of a specific embodiment of a memory address representation 530 for the row access mode for the specific embodiment shown in FIG. 4.

FIG. 6 shows a block diagram of the address generation circuitry for memory accesses.

FIG. 7 shows a block diagram of an embodiment of a data I/O controller.

FIG. 8 shows an embodiment of a timing diagram for the input and output signals of a graphics/video processor.

FIG. 9A shows an embodiment of a timing diagram for a read cycle in the word access mode.

FIG. 9B shows an embodiment of a timing diagram for a write cycle in the word access mode.

FIG. 10A shows an embodiment of a timing diagram for a read cycle in the block access mode.

FIG. 10B shows an embodiment of a timing diagram for a write cycle in the block access mode.

FIG. 11A shows an embodiment of a timing diagram for a read-to-write cycle in the block access mode.

FIG. 11B shows an embodiment of a timing diagram for a write-to-read cycle in the block access mode.

FIG. 12 shows an embodiment of a timing diagram for a block-read-modifyword write cycle.

### DETAILED DESCRIPTION

The present invention relates to an improvement in memories. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

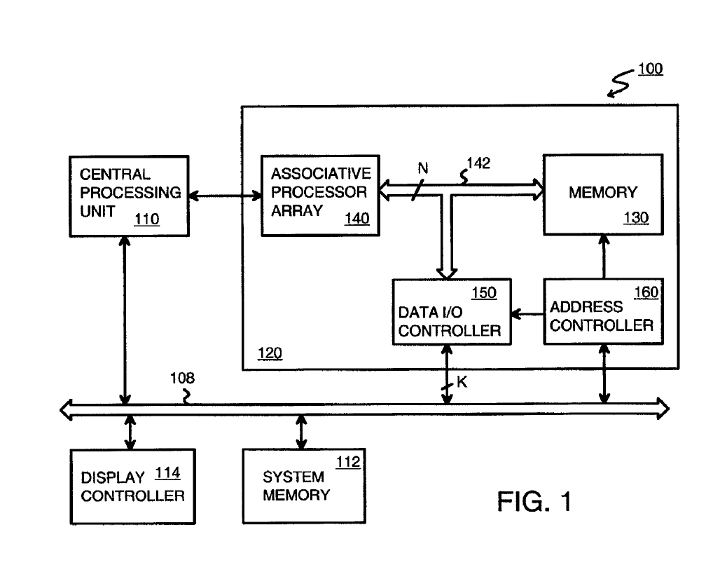

FIG. 1 shows a simplified block diagram of a specific embodiment of a graphics and video processing system 100. Processing system 100 can be incorporated in a personal computer, a digital video camera, a camcorder, and other devices. Processing system 100 includes a system bus 108 that interconnects a central processing unit (CPU) 110, a system memory 112, a display controller 114, and a graphics/video processor 120. CPU 110 executes a set of program codes that direct the operation of various units coupled to, or located within, processing system 100. System memory 112 stores program codes, data, and files, and is accessible via system bus 108. System memory 112 can be implemented as a RAM, a ROM, a FLASH memory, devices of other memory technologies, or a combination thereof. Display controller 114 receives data via system bus 108, processes the data, and drives a display device such as a television, a cathode ray tube (CRT), a liquid crystal display (LCD), an active matrix display, other types of display, or a combination thereof.

Graphics/video processor 120 receives video data via system bus 108, stores and processes the data, and provides the data to system bus 108 when requested. In an embodiment, graphics/video processor 120 includes a local memory 130 coupled to an associative processor array (APA) 140 via a wide data bus 142. A data input/output (I/O) controller 150 couples to data bus 142 and further to system bus 108 and facilitates data transfer between the buses. An address controller 160 couples to memory 130, data I/O controller 150, and system bus 108 and directs data transfer operations. Each of these elements is described in further detail below.

Memory 130 receives data from system bus 108, via data I/O controller 150, and stores the received data. When requested, memory 130 provides the data directly to associative processor array 120 via wide data bus 142 or to system bus 108 via data I/O controller 150, or both. Associative processor array 140 processes the data received from memory 130 (e.g., as directed by CPU 110) and provides the processed data back to memory 130. Data I/O controller 150 facilitates data transfer between memory 130 and system bus 108. Address controller 160 receives memory address and access information (from system bus 108 or an address bus that is not shown in FIG. 1) and directs the operation of memory 130 and data I/O controller 150.

As noted above, a graphics/video image or picture is composed of a S×T array of pixels, where S and T are typically defined by a particular video standard. An NTSC picture is typically digitized to 480×720 pixels and a PAL signal is typically digitized to 576×720 pixels. A JPEG picture can have resolution ranging from 1.8 M to 4.0 pixels (or greater), which can be defined by various combinations of lines and pixels/line (e.g., 1440×1280, 1600×1200, and so on). HDTV can have a resolution of 960×1440, 786×1440, or others depending on the particular HDTV system.

For enhanced performance, it is advantageous to provide a local memory “matched” to the pictures to be processed. For example, the memory can be dimensioned such that an entire line of a picture can be concurrently accessed, to allow for efficient processing of the entire line of the picture. The memory can also be sized to store a portion of a picture, an entire picture, or multiple pictures, depending on various design and cost considerations. The memory may further be sized to include additional storage capacity for other types of data (e.g., audio data) and program codes.

In a specific embodiment, the memory is sized to store sufficient amount of data for efficient processing of MPEG video (e.g., MPEG-1, MPEG-2, MPEG-4, and other MPEG standards defined in documents readily available in the art). The memory may be further sized to allow for efficient storage and processing of still images (e.g., JPEG) and audio data (e.g., Dolby AC-3).

In accordance with MPEG-2, an audio frame includes 1152 samples per frame per channel, or 4.6 kilo-bytes (KB) of data if each sample includes 16 bits of resolution. In accordance with AC-3, an audio frame includes 1536 samples per frame per channel, or 6.144 KB of data if each sample includes 16 bits of resolution. To support one frame from two channels of either MPEG- 1, MPEG-2, or AC-3 audio, a total of 12.288 KB of the memory can be allocated for audio data.

In a specific embodiment, the memory is configured to efficiently process NTSC pictures having a resolution of 480×720 pixels or PAL pictures having a resolution of 576×720 pixels, with each pixel having 8 bits of resolution. Each video line includes 5760 bits (i.e., 5760=720×8). The memory is thus configured with 5760 bits per column, which allows for efficient storage and access of an entire line of an NTSC or PAL picture. The depth of the memory is determined based on a number of considerations, such as the amount of video data desired to be stored, the physical size of the memory, the cost to implement the memory, and so on.

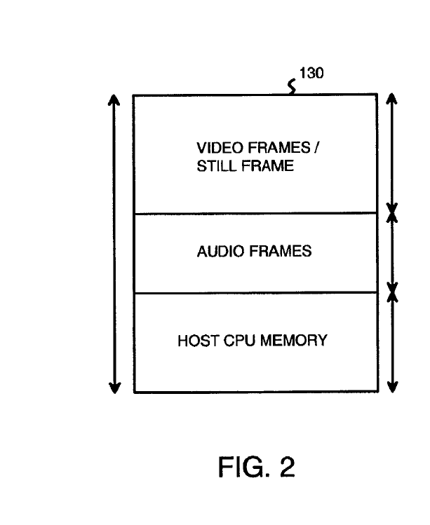

FIG. 2 shows a graphical representation of a specific partition of memory 130. Memory 130 includes a first section for storing several frames of video or a number of lines of a still picture, a second section for storing multiple audio frames, and a third section for data and program codes for the host processor (e.g. CPU 110). The size of each section can be selected based on a number of design considerations such as performance and cost. With the continual advancements in semiconductor processing technologies, larger memories having greater storage capabilities can be implemented.

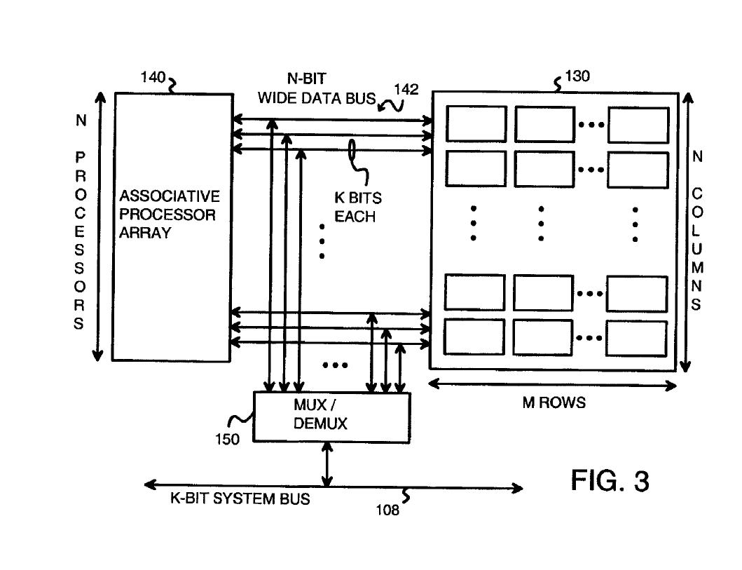

FIG. 3 shows a block diagram of a portion of graphics/video processor 120, which highlights the data bus interconnections between the elements in processor 120. As shown in FIG. 3, memory 130 includes M rows by N columns and couples via N-bit data bus 142 to associative processor array 140. In an embodiment, associative processor array 140 includes N processors that couple to N-bit data bus 142, one processor for each bit line of the data bus. This architecture allows for the concurrent transfer of up to N bits between memory 130 and associative processor array 140. In a specific embodiment, N is 5760 and selected to advantageously transfer up to one entire line of a picture having 720 pixels per line, with each pixel having 8 bits of resolution.

As shown in FIG. 3, data bus 142 also couples to system bus 108 via data I/O controller 150. Since data bus 142 includes N lines and system bus 108 includes K lines, with N being greater than K, data I/O controller 150 includes the necessary multiplexer (MUX) and demultiplexer (DEMUX) to couple N-bit data bus 142 to K-bit system bus 108. Data I/O controller 150 is described in further detail below.

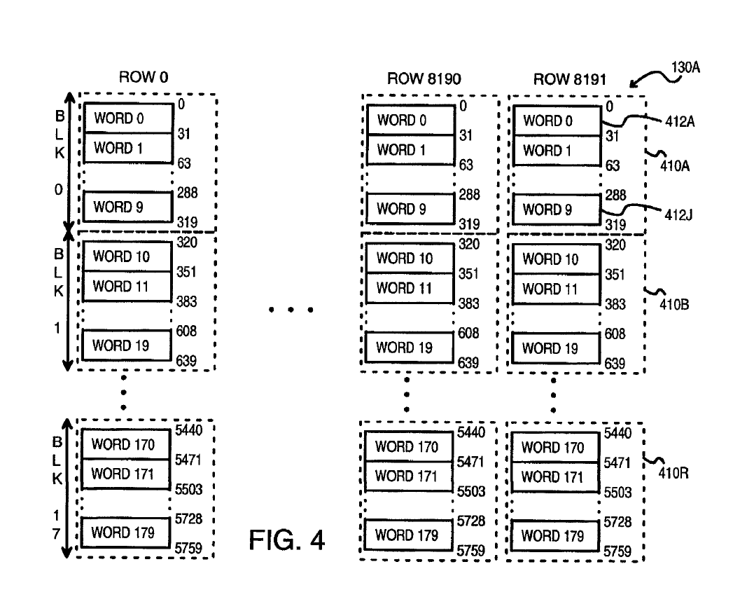

FIG. 4 shows a diagram of a specific embodiment of a memory 130a, which is a specific implementation of memory 130. In this specific embodiment, memory 130a includes 8192 rows by 5760 columns of memory cells. Each row is partitioned into eighteen data blocks 410a through 410r, with each block comprising ten words 412a through 412j and each word comprising 32 bits of data (each block thus includes 320 bits). Thus, each row includes 180 words, with word 0 including bits 0 through 31, word 1 including bits 32 through 63, and word 179 including bits 5728 through 5759.

In the specific embodiment shown in FIG. 4, each word includes 32 bits of data. However, different word widths can be used and are within the scope of the invention. The word width is typically matched to the system bus and/or the processor (e.g., CPU 110). The word width may also be selected based on a tradeoff between performance and power, and may be dependent on the required data transfer rate.

In accordance with an aspect of the invention, multiple accessing modes are provided to access memory 130. As used herein, a memory access can refer to a read from the memory or write to the memory. In an embodiment, the accessing modes include a word access mode, a block access mode, and a row access mode. The word access mode is used to access a particular K-bit word from a particular row of memory 130, the block access mode is used to access one or more blocks of a particular row, and the row access mode is used to access an entire row of the memory. The word access mode can be used by various units coupled to system bus 108 to access memory 130. The block and row access modes can be used to transfer data between memory 130 and associative processor array 140.

In the word access mode, data is accessed from memory 130 in one word unit (e.g., 32 bits). Address controller 160 receives and decodes a memory address into the corresponding row and column addresses for memory 130. In a specific embodiment, for ease of implementation, words are accessed at word boundaries. If a requested word is not aligned to a word boundary, two neighboring words located on the two sides of the word boundary are accessed and the requested word is then extracted from the accessed words.

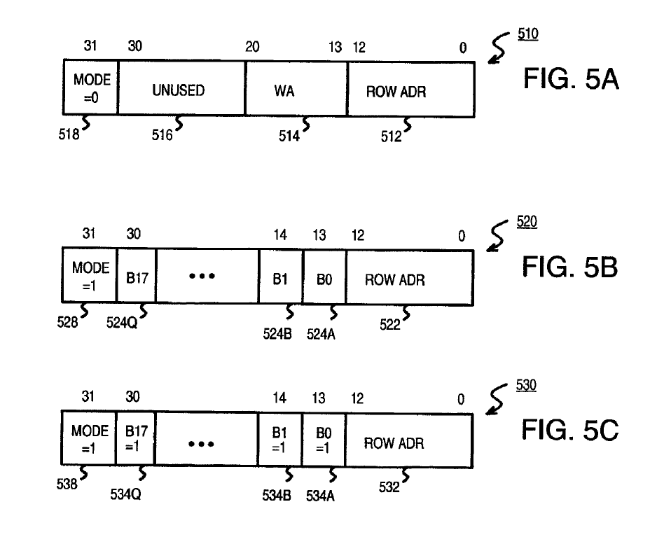

FIG. 5A shows a diagram of a specific embodiment of a memory address representation 510 for the word access mode. Memory address representation 510 corresponds to the specific embodiment in FIG. 4 in which memory 130a includes 8192 rows and 5760 columns. As shown in FIG. 5A, a row address (RADR) field 512 (comprised of bits 0 through 12) identifies a particular row out of 8192 rows in the memory, a word address (WA) field 514 (comprised of bits 13 through 20) identifies a particular word out of 180 words for each row, and a mode bit 518 (e.g., Mode 0) identifies the word access mode. An unused field 526 (comprised of bits 21 through 30) can be used for address information for larger sized memories or for some other purposes. For example, the bits in unused field 516 can be used to access multiple words or sets of words in a word access operation.

Table 1 shows the word addresses and their associated bits for a particular row of memory. As shown in Table 1, the words in the row are numbered sequentially from 0 to 179. Eight bits WA[7:0] are used to identify one of 180 words in the row.

TABLE 1

| Word Address WA[7:0] | Word Number | Bit Number |
|---|---|---|
| 0 | 0 | 0-31 |
| 1 | 1 | 32-63 |
| 2 | 2 | 64-95 |
| 3 | 3 | 96-127 |
| ... | ... | ... |
| 176 | 176 | 5632-5663 |
| 177 | 177 | 5664-5695 |
| 178 | 178 | 5696-5727 |
| 179 | 179 | 5738-5759 |

In the block access mode, data is accessed from memory 130 in units of blocks (e.g., 320 bits). In an embodiment, one or more blocks can be enabled for read or write in one memory access operation. Address controller 160 receives and decodes a memory address into the corresponding row address and block select signal(s) for memory 130.

FIG. 5B shows a diagram of a specific embodiment of a memory address representation 520 for the block access mode for the specific embodiment shown in FIG. 4. As shown in FIG. 5B, a row address field 522 (comprised of bits 0 through 12) identifies a particular row of memory and a mode bit 528 (e.g., Mode =1)identifies the block access mode. A set of block select fields 534a through 534q comprised of bits 13 through 31) identifies and enables one or more data blocks to be accessed. In an embodiment, one block select bit is provided for each block in a row of memory, with bits 13 through 30 corresponding to blocks 0 through 17, respectively. When the bit in the block select field is set to “1”, the block corresponding to this bit is enabled and accessed. Alternatively, setting the bit in the block select field to “0” disables the corresponding block during the memory access.

The block access mode allows for concurrent access of one or more blocks in the memory by simply setting the associated block select field(s) to “1”. The use of one block select bit for each block in a row provides several advantages. First, the blocks can be randomly selected and do not need to be a contiguous portion of the memory. Second, a decoder is not necessary to decode the column address information. The bits in the block select field can be used directly to enable or disable the associated blocks. The block access mode can be advantageously used for processing a region of data and can also be used to perform read or write operations on selected slices of data.

Table 2 shows the block select bits and the associated blocks and bits for a row of memory. As shown in Table 2, the block select bits and the blocks in the row are numbered sequentially from 0 to 17. Eighteen bits can be used to implement 18 block select signals used to control 18 blocks in each row.

TABLE 2

| Block Select Bit | Block Number | Bit Number |
|---|---|---|
| BS0 | 0 | 0-319 |
| BS1 | 1 | 320-639 |
| BS2 | 2 | 640-959 |
| BS3 | 3 | 960-1279 |
| ... | ... | ... |
| BS13 | 14 | 4480-4799 |
| BS14 | 15 | 4800-5119 |
| BS15 | 16 | 5120-5439 |
| BS17 | 17 | 5440-5759 |

In the row access mode, an entire row of data (e.g., 5760 bits) is accessed from memory 130. In an embodiment, the row access mode is a superset of the block access mode in which all blocks are selected for access. Address controller 160 receives and decodes a memory address into the corresponding row address and block select signals for memory 130.

FIG. 5C shows a diagram of a specific embodiment of a memory address representation 530 for the row access mode for the specific embodiment shown in FIG. 4. As shown in FIG. 5C, a row address field 532 (comprised of bits 0 through 12) identifies a particular row in memory and a mode bit 538 (e.g., Mode =1) identifies the block access mode. A set of block select fields 534a through 534q (comprised of bits 13 through 30) identifies the blocks to be accessed. In the row access mode, the bits for all block select fields are set to “1”. The row access mode can be advantageously used for transferring an entire line of video data between memory 130 and associative processor array 140.

FIGS. 4 and 5A through 5C describe a specific embodiment of memory 130a. In general, memory 130 can be implemented with any number of (M) rows and any number of (N) columns. Each row can be partitioned into any number of (B) blocks, and each block can include a particular number of (W) words. Each word can be defined to include any number of bits, but typically includes 8, 16, 32, 64, or 2^{×} bits, where × is a positive integer. For a memory address comprised of G bits (e.g., G=32), log₂(M) bits are used to identify a particular one of M rows, one bit is used to identify the word or block access mode, and the remaining bits can be used to implement up to (G−log₂(M)−1) block select lines. The size of the block can be defined such that the memory address includes one block select bit for each block in a row. This can be ensured by defining the block size such that B is less than or equal to (≲) G−log₂(M)−1 (e.g., 18≲32−log₂(8192)−1). Larger block sizes correspond to fewer numbers of blocks per row, which may result in unused bits in the memory address. Alternatively, smaller block sizes correspond to greater numbers of blocks per row, which may require coding of the block select bits or the use of multiple memory addresses to identify the selected blocks in the memory.

As the number of rows increases or reduces, the number of bits needed to identify a particular row in the memory may change. For a fix-size (e.g., 32-bit) memory address, the block size may be defined in a manner that most efficiently utilizes the available bits in the memory address. For example, if the number of rows in the memory doubles (e.g., to 16,384), an additional bit is needed for the row address and the block size can be modified such that one less block select signal is needed (e.g., 17 or fewer blocks per row).

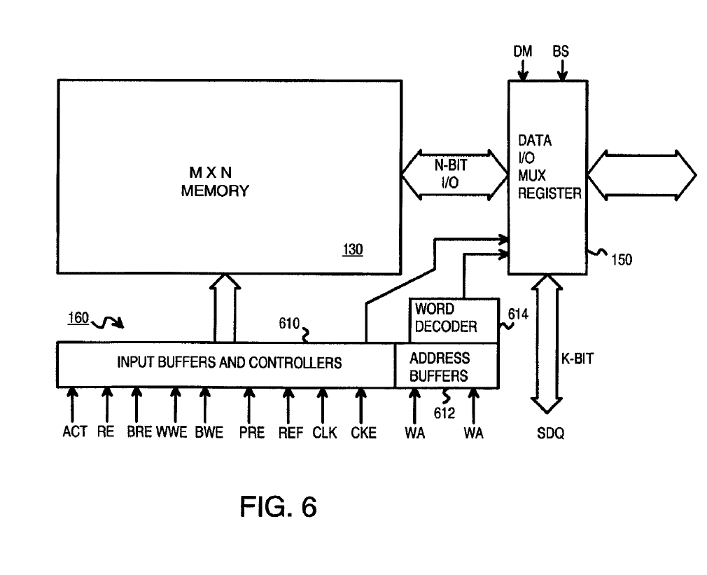

FIG. 6 shows a block diagram of the address generation circuitry for memory accesses. For each memory access (e.g., between memory 130 and associative processor array 140, or between memory 130 and system bus 108), address controller 160 receives and decodes a memory address and enables a selected portion of memory 130 for access.

In the specific embodiment shown in FIG. 6, address controller 160 includes input buffers and controllers 610, address buffers 612, and a word decoder 614. Input buffers and controllers 610 receive and process a set of clock, control, and enable signals that direct the operation of memory 130. Address buffers 612 receive and buffer the row and column addresses and forward the information to word decoder 614. Word decoder 614 receives and decodes the address information and provides control signals to data I/O controller 150. In a specific embodiment, the control signals and their descriptions are shown in Table 3.

TABLE 3

| Signal | Name | Description |
|---|---|---|
| ACT | Row | ACT going High activates a particular row in the |
| | Activation | memory identified by the row address RA. |
| WRE | Word Read | WRE going High enables the Word Read |
| | Enable | operation. |
| BRE | Block Read | BRE going High enables the Block Read |
| | Enable | operation. |
| WWE | Word Write | WWE going High enables the Word Write |
| | Enable | operation. Input data is written into the I/O |
| | | registers. BWE and WWE going High together in |
| | | the same clock cycle causes a transfer of data in |
| | | the I/O registers into the memory. |
| BWE | Block Write | BWE going High enables the Block Write |
| | Enable | operation. |
| PRE | Precharge | PRE is used to deactivate the selected (i.e., open) |
| | | row and to pre-charge the bit-lines. Pre-charge |
| | | is performed before another row is activated. |
| REF | Auto | REF going High starts the Auto Refresh cycle. |
| | Refresh | The refresh address is generated by an internal |
| | | refresh counter. Pre-charge is performed at the |
| | | end of the refresh cycle. |
| CLK | Memory | Input and output data for the memory are |
| | Clock | clocked with the CLK signal. |
| CKE | Clock | when CKE = High, CLK is enabled. CKE may be |
| | Enable | used to power down the input buffers and |
| | | analog circuits. When CKE = Low, CLK is |
| | | disabled, all inputs are ignored, and the memory |
| | | is powered down. |
| RA | Row | The row address that identifies one of M (e.g., |
| | Address | 8192) rows in the memory. |
| WA | Word | The column address that identifies one of N/K |
| | Address | (e.g., 180) words in a particular row. |
| DM | Data Mask | Used in Word Access Mode for Byte Write |
| | | operation. DM0 = High prevents bits 0-7 from |
| | | being written into the memory; DM1 = High |
| | | prevents bits 8-15; DM2 High prevents bits 16- |
| | | 23; and DM3 = High prevents bit 24-31. |
| | | DM[0:3] Low enables the writing of the word. |
| BS | Block | Each block select line enables a respective one of |
| | Select | B (e.g., 18) blocks during the Block Access |
| | | Mode. |
| ADQ | Wide-Bus | The wide data bus that is active during the Block |
| | Data I/O | Access Mode. |
| SDQ | System | The system bus that is active during the Word |
| | Data-Bus | Access Mode. |
| | I/O | |

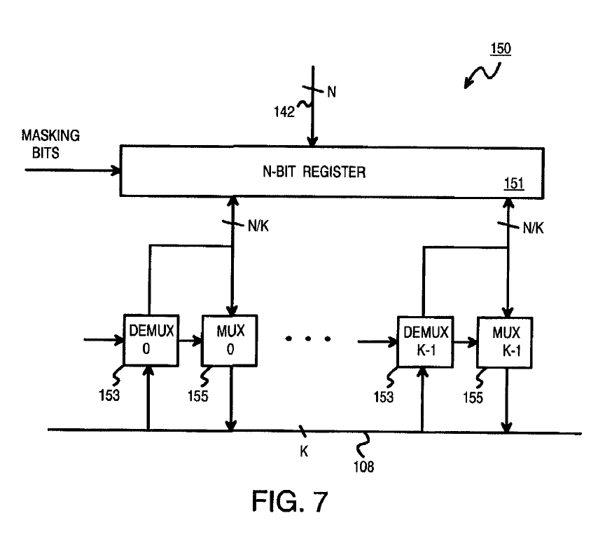

FIG. 7 shows a block diagram of an embodiment of data I/O controller 150. In a specific embodiment, for a read operation from memory 130 in the word access mode, all N bits are accessed from wide data bus 142 and latched into data I/O controller 150, thereby making all N bits in a particular row available for access via system bus 108. The selected K-bit word is then clocked out from registers 151 in data I/O controller 150. Other words in the same row can also be clocked out in sequential or random order.

Conventionally, accessing data from a memory via the system bus requires repeated access to the memory. A word in a particular row and column is activated, and the selected word is retrieved from memory. To access another word, the process is repeated and the same or other row/column are selected for access. This process ties up a high throughput memory when accessed by a low throughput bus.

To alleviate the bottleneck caused by the word access mode, an entire row of data is latched into register 151 in data I/O controller 150 for a word access operation. Once the data in the row is latched, memory 130 is no longer in the critical path and can be accessed by associative processor array 140 or other units. Also, power consumption is reduced since only one data transfer is performed for an entire row of data between memory 130 and data I/O controller 150.

Typically, one word is clocked out from data I/O controller 150 to system bus 108 on each clock cycle. However, any subset of the latched data can be clocked out on any clock cycle. One or more subsets can also be clocked out in sequential or random order.

Wide data bus 142 is an N-bit bus, while system bus 108 is a smaller K-bit bus. Multiplexers 155 select one of N/K lines from registers 151 to be driven to a line of system bus 108 when reading the memory. For writes to memory, de-multiplexers 153 route each data bit from system bus 108 to one of N/K bits in register 151. A total of K multiplexers 155 and K de-multiplexers 153 are used in an embodiment. De-multiplexers 153 can be integrated with gating or enable logic in registers 151.

In a specific embodiment, for a write operation to memory 130 in the word access mode, words from system bus 108 are latched (e.g., one K-bit word at a time) in registers 151 within data I/O controller 150. Once registers 151 are filled, a write operation for up to N bits is performed to memory 130.

In an embodiment, each byte of each word in the registers is associated with a mask bit that determines whether that byte is to be written to memory. Alternatively or additionally, each word of a particular block can be associated with a mask bit to allow for masking of words at the block level.

In an embodiment, a read-modify-write is performed. A write operation is performed on all bits in a particular row. Only bits that have not been masked are modified (e.g., written to) in the memory.

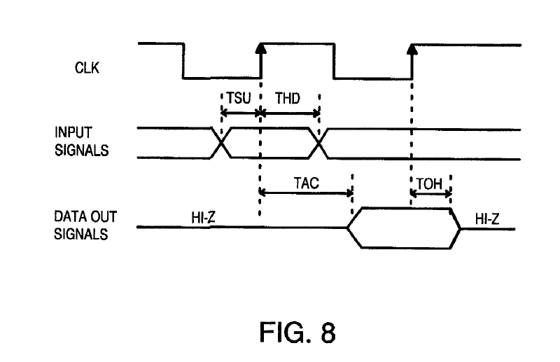

FIG. 8 shows an embodiment of a timing diagram for the input and output signals of graphics/video processor 120. The input signals are latched on a rising edge of the clock signal CLK and meet particular setup time (t_{SU}) and hold time (t_{HD}) requirements. The input signals include, for example, the WRE, WWE, PRE, REF, RA[0:12], WA[0:7], and ADQ[0:5759] and SDQ[0:31] when they act as input signals. The output signals include ADQ[0:5759] and SDQ[0:31] when they act as output signals.

As shown in FIG. 8, the output signals are valid a particular access time (t_{AC}) from a preceding rising clock edge, and are valid until a particular hold time (t_{OH}) after the current rising clock edge that can be used to latch the output signals. In an embodiment, ADQ[0:5759] is in a high impedance (Hi-Z) state during the word access mode and SDQ[0:31] is in the high impedance state during the block access mode.

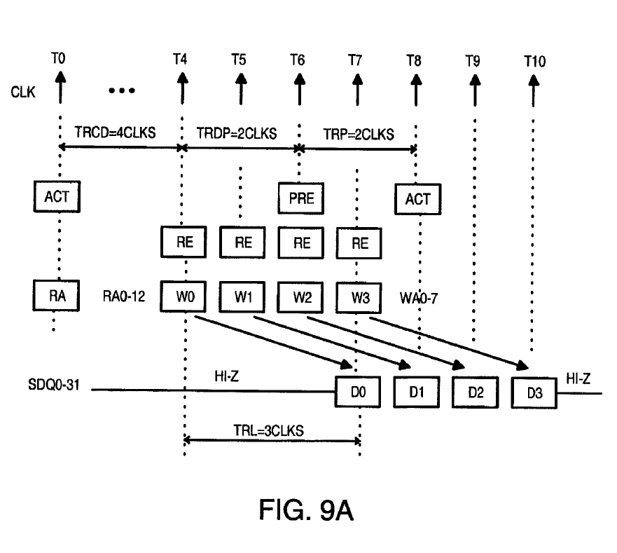

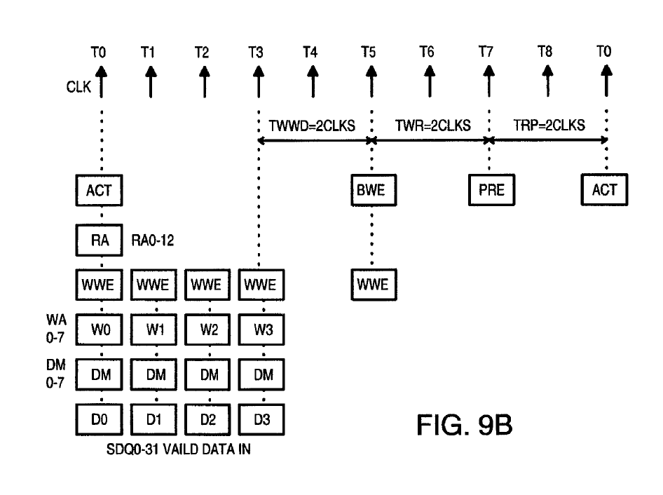

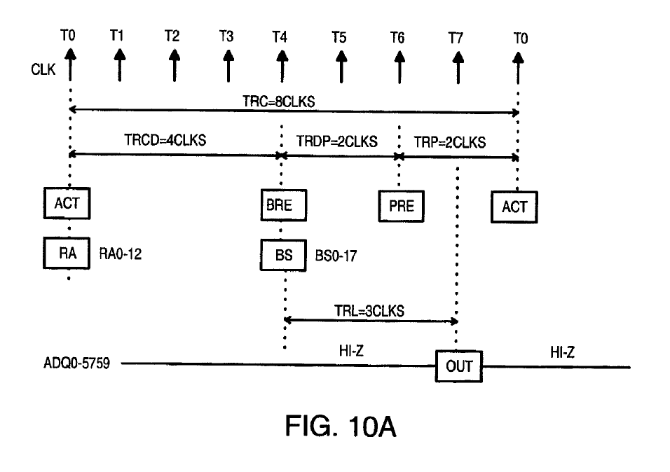

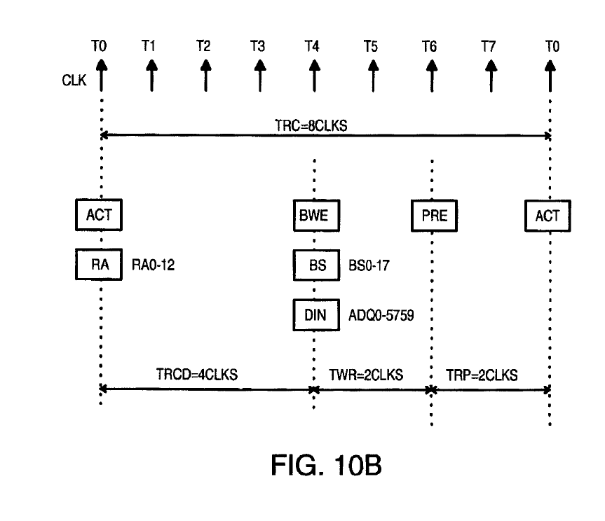

FIG. 9A shows an embodiment of a timing diagram for a read cycle in the word access mode. As shown in FIG. 9A, the row activation signal ACT and row address RA are received on the rising edge of clock cycle T0. The selected row is then read from memory 130 and the data is latched in the register of data I/O controller 150. The word read enable BRE and word address WA of the first selected word W0 are provided during the rising edge of clock cycle T4. Three clock cycles later, the word D0 corresponding to word address W0 is provided on system bus 108. Other words can be provided from the register to the system bus, one word per clock cycle, until all desired words are read from register. As shown in FIG. 10A, the SDQ lines are tri-stated (Hi-Z) at all times, except when a word is provided to the SDQ lines. In an embodiment, a read cycle in the word access mode is performed over eight or more clock cycles (i.e., a new read cycle can begin every eighth clock cycle).

FIG. 9B shows an embodiment of a timing diagram for a write cycle in the word access mode. The row activation signal ACT, the row address RA, the word write enable WWE, the first word address W0, the first data word D0, and the data mask DM corresponding to data word D0 are valid during the rising edge of clock cycle T0. The data word D0is latched into the register of data I/O controller 150. Additional words to be written to memory 130 (or provided to associated processor array 140) and their corresponding data masks are latched on subsequent clock edges, one word per clock cycle, until all words to be written to the memory are latched. Two clock cycles later, the block write enable BWE and the word write enable WWE are activated, thereby transferring the selected words from the register into memory 130. In a specific embodiment, each word is associated with three masking bits DM[0:3], one bit for each byte of the word, that determine whether the bytes in the word are to be written to memory. Two clock cycles after this, the precharge PRE line is asserted to deactivate the selected row and to precharge the bit lines corresponding to the bits to be written. The writing to the actual memory cell can take place immediately, or several cycles later, depending on the pipeline depth. Writing to the actual memory cell can be performed after T5 and before T7 in FIG. 9B.

FIG. 10A shows an embodiment of a timing diagram for a read cycle in the block access mode. The row activation signal ACT and row address RA are received on the rising edge of clock cycle T0. The block read enable BRE and block select lines BS are activated during the rising edge of clock cycle T4. Two clock cycles later, the precharge PRE line is asserted to deactivate the selected row and to precharge the bit lines corresponding to the bits to be accessed. The accessed bits are then available on the ADQ lines at the rising edge of clock cycle T7. As shown in FIG. 9A, the ADQ lines are tri-stated (Hi-Z) at all times during the block read cycle, except for a time period around the clock cycle T7. The read cycle can then be repeated for the next block.

In an embodiment, the edges of the transitions on the ADQ lines are selected (and/or controlled) to reduce the amount of peak current during transitions. Reducing peak current is especially important since 5760 lines are activated substantially concurrently for a block read cycle.

FIG. 10B shows an embodiment of a timing diagram for a write cycle in the block access mode. The row activation signal ACT and row address RA are received on the rising edge of clock cycle T0. The block write enable BWE, the block select lines BS, and the data on the ADQ lines are available during the rising edge of clock cycle T4. Two clock cycles later, the precharge PRE line is asserted to deactivate the selected row and to precharge the bit lines corresponding to the bits to be accessed. The write cycle can then be repeated for the next block.

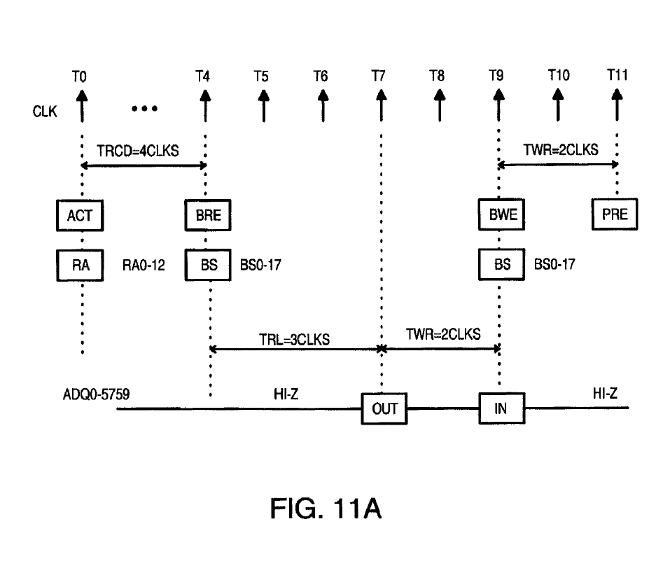

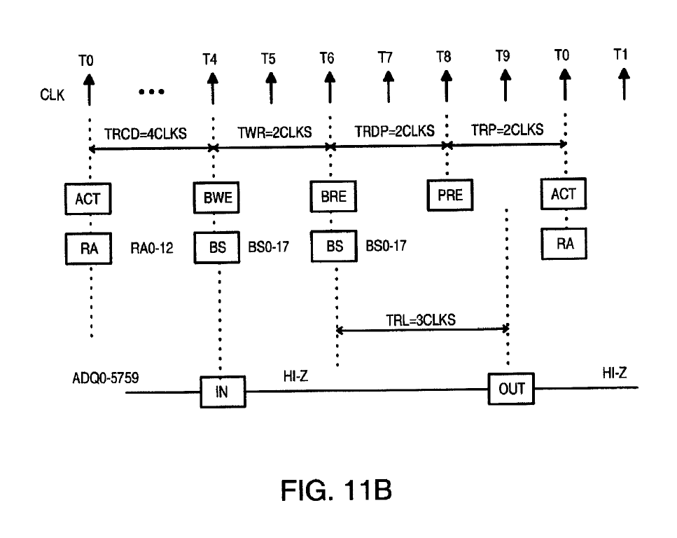

FIG. 11A shows an embodiment of a timing diagram for a read-to-write cycle in the block access mode. A read cycle is immediately followed by a write cycle with minimum delay. The row activation signal ACT and row address RA are received on the rising edge of clock cycle T0. The block read enable BRE and block select lines BS are activated during the rising edge of clock cycle T4. Three clock cycles later, the data from the selected row of memory is available on the wide data bus ADQ. Two clock cycles after, the block write enable BWE, block select lines BS, and data on the wide data bus are made available. Two clock cycles after, precharge line PRE is activated.

FIG. 11B shows an embodiment of a timing diagram for a write-to-read cycle in the block access mode. A write cycle is immediately followed by a read cycle with minimum delay. The row activation signal ACT and row address RA are received on the rising edge of clock cycle T0. The block read enable BRE, block select lines BS, and data on the ADQ lines are valid during the rising edge of clock cycle T4. Two clock cycles later, the block read enable BRE and block select lines BS are activated Two clock cycles later, precharge line PRE is activated. The output data is available on the ADQ lines during the rising edge of clock cycle T9.

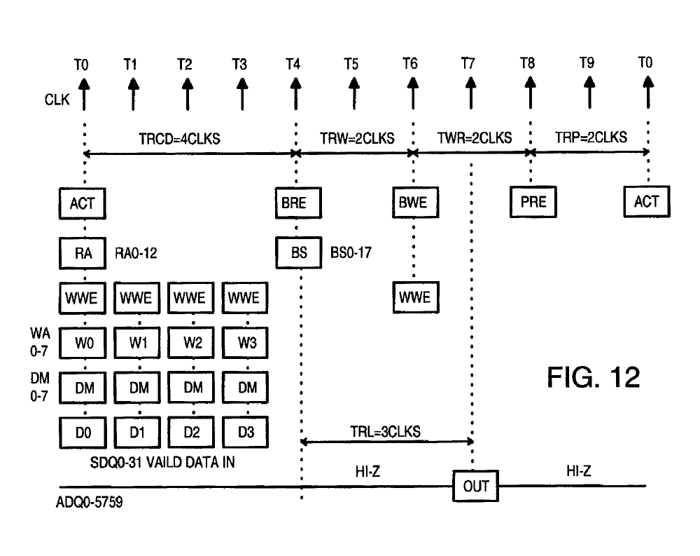

FIG. 12 shows an embodiment of a timing diagram for a block-read-modifyword write cycle. This read/write cycle is used to read bits from a row of memory, write bits to the same row, and modify only bits that have not been masked.

### ALTERNATE EMBODIMENTS

Several other embodiments are contemplated by the inventors and several alternatives have been described. Of course, any advantages and benefits described may not apply to all embodiments of the invention.

The picture can conform to one of many standards, such as JPEG, MPEGMPEG-4, HDTV, and others, with the number of bits/pixel being 8 bits, 24 bits (e.g., 8 bits for each of red, green, and blue), or some other values.

The abstract of the disclosure is provided to comply with the rules requiring an abstract which will allow a searcher to quickly ascertain the subject matter of the technical disclosure of any patent issued from this disclosure. It is submitted with the understanding that it will not be used to interpret or limit the scope or meaning of the claims. 37 C.F.R. § 1.72(b). Any advantages and benefits described may not apply to all embodiments of the invention. When the word “means” is recited in a claim element, Applicant intends for the claim element to fall under 35 USC § 112, paragraph 6. Often a label of one or more words precedes the word “means”. The word or words proceeding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word means are not intended to fall under 35 USC § 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A data processing system comprising:
a memory unit including a plurality of memory cells, wherein the memory unit is logically configured into M rows by N columns, with each row comprising B blocks and each block comprising W words, wherein M, N, B, and W are whole numbers greater than 1; and
a wide data bus coupled to the memory unit, the wide data bus comprising at least 1024 lines,
wherein the memory unit is accessible via one of a plurality of access modes,
wherein the plurality of access modes comprises a row access mode operable to access an entire row of memory cells and a word access mode operable to access a particular word in the memory unit.

2. The system of claim 1 further comprising:
an associative processor array coupled to the wide data bus, the associative processor array configurable to receive and process data provided on the wide data bus.

3. The system of claim 2 wherein the associative processor array comprises a plurality of data processors, each data processor coupled to a respective line of the wide data bus.

4. The system of claim 2 wherein the associative array processor accesses the memory unit using the row access mode, the associative array processor accessing an entire row of memory cells.

5. The system of claim 2 wherein the plurality of access modes further comprise a
block access mode operable to access one or more blocks in a particular row.

6. The system of claim 5 wherein the one or more accessed blocks are arbitrarily selectable from among the B blocks in the particular row.

7. The system of claim 1 further comprising:
a data I/O controller coupled to the wide data bus, the data I/O controller configured to provide an interface between the wide data bus and a system bus.

8. The system of claim 7 wherein the data I/O controller comprises
a plurality of multiplexers, each multiplexer coupled to a respective set of lines of the wide data bus and one line of the system bus.

9. The system of claim 7 wherein the data I/O controller comprises
a plurality of demultiplexers, each demultiplexer coupled to a respective line of the system bus and a set of lines of the wide data bus.

10. The system of claim 7 wherein the data I/O controller comprises
a first register coupled to the wide data bus and operable to latch data provided on the wide data bus.

11. The system of claim 10 wherein the first register is operable to concurrently latch N bits provided on the wide data bus.

12. The system of claim 10 wherein the first register is operable to provide one or more subsets of the latched data, in a selectable order, to the system bus.

13. The system of claim 7 wherein the data I/O controller comprises:
a second register coupled to the wide data bus and operable to latch data received from the system bus.

14. The system of claim 10 wherein the second register is associated with a set of masking bits, and wherein each masking bit selectively enables or inhibits writing of an associated set of data bits from the second register to the memory unit during a write operation.

15. The system of claim 7 wherein the memory unit is accessed by providing a control input that comprises a row address and a mode select field, the mode select field identifying one of the plurality of access modes.

16. The system of claim 15 wherein the control input comprises an address of a selected word for a word access mode.

17. The system of claim 15 wherein the control input comprises a block select field for a block access mode, the block select field comprising a set of block select bits with each block select bit associated with a respective one of the B blocks in a row of memory cells.

18. The system of claim 15 wherein the control input comprises 32 bits.

19. The system of claim 2 wherein the wide data bus comprises 5760 lines.

20. The system of claim 2 wherein the wide data bus is matched to a number of bits in a line of a video picture or an image to be processed.

21. The system of claim 2 wherein the memory unit comprises at least 8192 rows.

22. The system of claim 2 wherein a size of the blocks is determined, in part based on the number of bits available in a control word used for accessing the memory unit and the number of rows in the memory unit.

23. A dynamic random access memory comprising the memory unit and the wide data bus of claim 2.

24. An embedded processor comprising the memory unit and the wide data bus of claim 2.

25. A data processing system configurable to store and process graphics or video data, comprising:
a memory unit comprising a plurality of memory cells, wherein the memory unit is logically configured into M rows by N columns, with each row comprising B blocks and each block comprising W words, wherein M, N, B, and W are numbers greater than 1;
an N-bit data bus coupled to the memory unit, the N-bit data bus comprising N lines, one line for each column of the memory unit;
an associative processor array coupled to the N-bit data bus and configured to receive and to process data provided on the N-bit data bus; and
a data I/O controller coupled to, and configured to provide an interface between, the N-bit data bus and a K-bit system bus.

26. A circuit configurable to process graphics or video data, comprising:
a memory array comprising a plurality of memory cells, wherein the memory array is logically configured into M rows by N columns, with each row comprising B blocks and each block comprising W words; and
an address controller operatively coupled to the memory array, the address controller configured to provide a set of block select signals, one block select signal for each block in a row,
wherein one or more blocks in a particular row is assessed by asserting one or more associated block select signals.

27. The circuit of claim 26 wherein an entire row of the memory array is assessed by asserting all block select signals.

28. A memory architecture configurable to store video data, comprising:
a memory unit comprising M rows by N columns of memory cells; and an N-bit data bus coupled to the memory unit,
wherein the memory unit is accessed via one of a plurality of access modes that comprise a row access mode, a block access mode, and a word access mode, and wherein the word access mode is operable to access a particular word in a particular row and the block access mode is operable to access one or more blocks in the particular row and the row access mode is operable to access the particular row.
